(19) United States
(12) Patent Application Publication
(10) Pub. No.: US 2022/0306968 A1
(43) Pub. Date: Sep. 29, 2022

(54) METHODS AND COMPOSITIONS FOR CLEANING

(71) Applicant: DANISCO US INC, Palo Alto, CA (US)

(72) Inventors: Jonathan LASSILA, PALO ALTO, CA (US); Cliff LAY, PALO ALTO, CA (US); Abigail K. LUCKRING, WEST CHESTER, PA (US); Sergio Anibal SUNUX, PALO ALTO, CA (US); Kun ZHONG, Shanghai (CN)

(21) Appl. No.: 17/616,033

(22) PCT Filed: Jun. 4, 2020
(86) PCT No.: PCT/US2020/036056

§ 371 Date: Dec. 2, 2021

Related U.S. Application Data
(60) Provisional application No. 62/858,000, filed on Jun. 6, 2019.

(51) Int. Cl. C11D 3/386; C11D 11/00; C11D 3/48

(52) U.S. Cl. CPC C11D 3/38636; C11D 11/0017; C11D 11/0023; C11D 3/48

(57) ABSTRACT

Disclosed herein are compositions and methods for preventing, reducing, or removing biofilms.

The present application claims priority to U.S. Provisional Application 62/858,000, filed Jun. 6, 2019 the entirety of which is hereby incorporated by reference.

The present disclosure relates to compositions and methods for cleaning, for example hard surface and laundry cleaning.

### REFERENCE TO SEQUENCE LISTING SUBMITTED ELECTRONICALLY

The official copy of the sequence listing is submitted electronically via EFS-Web as an ASCII formatted sequence listing with a file named 20200604_NB41566PCT_ST25, created on Jun. 4, 2020 and having a size of 4 kilobytes and is filed concurrently with the specification. The sequence listing contained in this ASCII formatted document is part of the specification and is herein incorporated by reference in its entirety.

### BACKGROUND

Trends toward cold water washing and synthetic athletic wear are driving a need for detergents that eliminate bacteria and odor, while at the same time the industry is moving away from laundry powders where traditional oxygen bleach was feasible. Thus, a need exists for new approaches to remove malodor and microorganisms in laundry.

Formation of bacterial biofilms in washing machines and on laundry textiles contributes to the spread of harmful and malodorous bacteria. Biofilm formation increases the resistance of bacteria to removal and cleaning processes. This resistance is mediated by production of a biofilm extracellular matrix consisting of water, polysaccharides, proteins, nucleic acids, and lipids. Enzymes that degrade these extracellular matrix components may be one option to investigate to reduce, inhibit, or remove bacterial biofilms.

Despite repeated exposure to surfactants, proteases, and amylases from typical laundry detergents, bacterial biofilms persist in washing machines and contribute to hygiene and odor problems. More effective solutions for removing biofilms in laundry are thus needed.

### SUMMARY

One embodiment is directed to methods for preventing, reducing or removing a biofilm comprising contacting the biofilm with a cleaning composition comprising a polypeptide having thermolysin activity.

Another embodiment is directed to methods for preventing, reducing or removing a biofilm comprising contacting the biofilm with a polypeptide having thermolysin activity or a composition comprising a polypeptide having thermolysin activity. In some embodiments, the biofilm is on a textile or hard surface.

Another embodiment is directed to methods for preventing, reducing or removing a biofilm from a textile or hard surface comprising: (i) contacting a textile or surface with a polypeptide having thermolysin activity or a composition comprising a polypeptide having thermolysin activity; and (ii) optionally, rinsing the textile or surface.

Another embodiment is directed to a detergent composition comprising: (i) a polypeptide having thermolysin activity; (ii) a polypeptide having protease activity; (iii) at least one additional polypeptide, where the at least one additional polypeptide is an enzyme selected from: DNase, acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases, oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof; and (iv) a surfactant.

### FIGURES

FIG. 1 provides a graphic representation of the results of one embodiment, of biofilm reduction with Proteinase T (270 PPM) with two independently grown batches of biofilm. The biofilm signal in the presence of 270 PPM Proteinase T was 6.7% of the no-enzyme control in (A) and 7.3% of the no-enzyme control in (B).

FIG. 2 provides a graphic representation of the results of one embodiment of biofilm reduction with Proteinase T at 50 PPM, 100 PPM, and 300 PPM.

FIG. 3 provides a graphic representation of the results of one embodiment of an assay for P. fluorescens biofilm treated with varied concentrations of Proteinase T. Error bars indicate standard deviation of 4 trials. White circles represent untreated controls. Light gray circles represent laundry simulation wash alone with no enzyme. Dark gray circles represent varied doses of Proteinase T, as indicated. Black circles represent further purified thermolysin.

FIG. 4 provides a graphic representation of one embodiment of an S. epidermidis biofilm treated with varied concentrations of Proteinase T. Light gray circles represent untreated controls. Dark gray circles represent laundry wash with the given concentration of Proteinase T (10 PPM, 52 PPM, 260 PPM, or 1300 PPM).

FIG. 5 provides a graphic representation of one embodiment of the disclosure showing a plot of biofilm staining results (absorbance at 590 nm) in relation to various amounts of Proteinase T.

FIG. 6 provides a graphic representation of one embodiment of the disclosure showing a plot of data of density of the cell culture (optical density at 600 nm) in relation to various amounts of Proteinase T.

FIG. 7 provides a graphic representation of results of one embodiment of the disclosure from a midscale Launder-Ometer wash study. Absorbance at 590 nm after crystal violet staining and destaining is plotted for treatments with and without thermolysin.

FIG. 8 provides a graphic representation of results of one embodiment of the disclosure showing optical density at 600 nm, a measure of cell density, plotted for cultures after inoculation with fabric washed with and without Proteinase T in a Launder-Ometer model for laundry washing machine biofilms.

FIG. 9 provides a graphic representation of results of one embodiment of the disclosure showing results from an 11-member odor sensory panel asked to evaluate the odor strength of synthetic sweat solutions exposed to biofilms treated with and without thermolysin.

### DESCRIPTION

The present disclosure provides compositions (e.g. enzyme and detergent compositions) and methods using such compositions for the prevention, reduction or removal of biofilms, for example, from an article, such as a hard surface or textile. The compositions generally employ the use of at least one polypeptide having thermolysin activity or a composition comprising a polypeptide having thermolysin activity. The compositions also optionally comprise additional components of a cleaning detergent, such as one or more surfactants.

Prior to describing embodiments of present compositions and methods, the following terms are defined.

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “biofilm” refers to community of microorganisms embedded in an extracellular polymer matrix attached to a surface. The extracellular polymer matrix is a polymeric conglomeration generally composed of extracellular DNA, proteins, and polysaccharides. A biofilm may have one or more microorganisms and further includes water and may include other trapped particles. The microorganisms may be gram positive or gram-negative bacteria (aerobic or anaerobic); algae, protozoa, and/or yeast or filamentous fungi. In some embodiments the biofilm is living cells including one or more bacterial genera of Acinetobacter sp., Aeromicrobium sp., Brevundimonas sp., Microbacterium sp., Micrococcus luteus, Pseudomonas sp. (e.g. Pseudomonas fluorescens), Staphylococcus sp. (e.g. Staphylococcus epidermidis), and Sienotrophoinonas sp., Streptomyces sp., Listeria sp., Streptococcus sp., and Escherichia sp.

As used herein, “surface” means any structure having sufficient mass to allow for attachment of biofilm. Hard surfaces include, but are not limited to metal, glass, ceramics, wood, minerals (rock, stone, marble, granite), aggregate materials such as concrete, plastics, composite materials, hard rubber materials, and gypsum. The hard materials may be finished with enamels and paints. Hard surfaces are found, for example in water treatment and storage equipment and tanks; dairy and food processing equipment and facilities; medical equipment and facilities, such as surgical instruments and permanent and temporary implants; industrial pharmaceutical equipment and plants. Soft surfaces are, for example, hair and all types of textiles. Porous surfaces also may be found in certain ceramics as well as in membranes that are used for filtration. Other surfaces include, but are not limited to, ship hulls and swimming pools. Other surfaces may be biological surfaces, such as skin, keratin or internal organs.

The term “fabric” refers to, for example, woven, knit, and non-woven material, as well as staple fibers and filaments that can be converted to, for example, yarns and woven, knit, and non-woven fabrics. The term encompasses material made from natural, as well as synthetic (e.g., manufactured) fibers.

The term “textile”, as used herein, refers to any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well. In the context of the present application, the term “textile” is used interchangeably with fabric and cloth.

As used herein, the term “hard surface” refers to any article having a hard surface including floors, tables, walls, roofs etc. as well as surfaces of hard objects such as cars (car wash), ship hulls, dishes (dishware), medical instruments, pipes, reservoirs, or holding tanks. The term “hard surface” includes also the surfaces of flexible yet firm objects such as the insides of bendable tubing and supply lines or the surfaces of deformable holding tanks or vessels. The term “hard surface” includes also the surfaces in the interior of washing machines, such as the interior of laundry washing machines or dishwashing machines, this includes soap intake box, walls, windows, baskets, racks, nozzles, pumps, sump, filters, pipelines, tubes, joints, seals, gaskets, fittings, impellers, drums, drains, traps, coin traps inlet and outlets. The term hard surface does not encompass textile or fabric.

The term “laundering” includes both household laundering and industrial laundering and means the process of treating textiles with a solution containing a cleaning or detergent composition as provided herein. The laundering process can for example be carried out using e.g. a household or an industrial washing machine or can be carried out by hand.

The term “wash cycle” refers to a washing operation in which textiles are immersed in a wash liquor, mechanical action of some kind is applied to the textile to release stains or to facilitate flow of wash liquor in and out of the textile and finally the superfluous wash liquor is removed. After one or more wash cycles, the textile is generally rinsed and dried.

The term “wash liquor” is defined herein as the solution or mixture of water and detergent components optionally including polypeptides having thermolysin activity.

### Cleaning Methods

In one embodiment, methods for preventing, reducing or removing a biofilm are provided, where the methods comprise contacting the biofilm with a polypeptide having thermolysin activity or a composition comprising a polypeptide having thermolysin activity.

In another embodiment, the disclosure provides a method for preventing, reducing or removing a biofilm from a textile or hard surface, where the method comprises contacting a textile or hard surface with a polypeptide having thermolysin activity, or a composition comprising a polypeptide having thermolysin activity, and optionally rinsing the textile or hard surface.

In another embodiment, the disclosure provides methods for reducing the transfer of bacteria associated with a biofilm from a first textile or first hard surface to a second textile or second hard surface, the method comprising: (ii) contacting a first textile or first hard surface having at least one bacteria associated with a biofilm and a second textile or second hard surface with a polypeptide having thermolysin activity or a composition comprising a polypeptide having thermolysin activity; and (ii) optionally, rinsing the textile or surface. In some embodiments, the textile or hard surface comprises a biofilm on a surface of the textile or hard surface. In some embodiments, the transfer of bacteria from the first to the second textile or surface is reduced at least 5%, 10%, 15%, 20%, 25%, 30%, 35%, 40%, 45%, 50%, 55%, 60%, 65%, 70%, 75%, 80%, 85%, 90%, 95% or greater compared to the amount of the transfer measured after contacting in the absence of the polypeptide having thermolysin activity or a composition comprising a polypeptide having thermolysin activity. In some embodiments, the second textile and/or second hard surface also comprises at least one bacteria associated with a biofilm. In some embodiments, the first textile or first hard surface and the second textile or second hard surface may be contacted simultaneously or sequentially in separate wash cycles.

In another embodiment, the disclosure provides methods for reducing malodor associated with a textile or hard surface comprising: (i) contacting a textile or hard surface with a polypeptide having thermolysin activity or a composition comprising a polypeptide having thermolysin activity; and (ii) optionally, rinsing the textile or surface. In some embodiments, the textile or hard surface comprises a biofilm on a surface of the textile or hard surface. In some embodiments, the malodor is reduced at least 5%, 10%, 15%, 20%, 25%, 30%, 35%, 40%, 45%, 50%, 55%, 60%, 65%, 70%, 75%, 80%, 85%, 90%, 95% or greater compared to the amount of the malodor present prior to contacting the textile or hard surface with the polypeptide having thermolysin activity or a composition comprising a polypeptide having thermolysin activity.

In some embodiments, the malodor is reduced at least 5%, 10%, 15%, 20%, 25%, 30%, 35%, 40%, 45%, 50%, 55%, 60%, 65%, 70%, 75%, 80%, 85%, 90%, 95% or greater after 1, 2, 3, 4, or 5 or more wash cycles compared to the amount of the malodor present in a textile or hard surface not contacted with the polypeptide having thermolysin activity or a composition comprising a polypeptide having thermolysin activity.

In one embodiment, the textile or hard surface comprises a biofilm, for example, on its surface. In one embodiment, the biofilm is reduced by at least about 10%, 15%, 20%, 25%, 30%, 35%, 40%, 45%, 50%, 55%, 60%, 65%, 70%, 75%, 80%, 85%, 90%, 95%, or more from the amount of the biofilm present on the surface or textile prior to contacting the surface or textile with the polypeptide having thermolysin activity or a composition comprising a polypeptide having thermolysin activity. In one embodiment, the level of reduction in the biofilm present on the surface or textile is assayed using a method available in the art to determine biofilm removal. In one embodiment, the biofilm level can be measured using the method provided in Examples 1, 2, 3, 4, 5, and 6 below.

In another embodiment, the prevention or reduction of a biofilm includes the reduction in the formation, growth, or proliferation of biofilm on a textile or hard surface. In one embodiment, the reduction in the formation, growth, or proliferation of biofilm on a textile or hard surface may be measured by following the change in the amount of the biofilm over a suitable time period with the method provided in Examples 1, 2, 3, 4, 5, and 6 below, or another suitable method in the art. For example, biofilm formation or growth may be inhibited in an amount ranging from 1% to about 99% relative to that of an untreated hard surface or textile. Biofilm formation may be inhibited by at least about 10%, at least about 20%, at least about 30%, at least about 40%, at least about 50%, at least about 60%, at least about 70%, at least about 80%, at least about 90%, or at least about 95% relative to biofilm formation on an untreated hard surface or textile. In another embodiment, the formation of biofilm on a surface may be delayed over a number of laundry cycles (e.g. 1, 2, 3, 4, 5, or more cycles), compared to that of an untreated surface.

The textile or surface can be contacted with the polypeptide or a composition comprising the polypeptide having thermolysin activity in a washing machine or in a manual wash tub (e.g. for handwashing). In one embodiment, the textile or surface is contacted with the polypeptide having thermolysin activity or the composition comprising a peptide having thermolysin activity in a wash liquor. In another embodiment, a solution containing the polypeptide having thermolysin activity is incubated with or flowed over the hard surface, such as by pumping the solution through tubing or pipes or by filling a reservoir with the solution.

In some embodiments, the textiles or surfaces are contacted with the polypeptide or compositions comprising the polypeptide under conditions for any amount of time desired or for any period of time sufficient to prevent, reduce or remove biofilm from the textile. In one embodiment, the contacting step is between about 5 minutes and about 10 days. In some embodiments, the contacting takes place in a wash liquor for about 5 to about 400 minutes, between about 5 minutes to about 300 minutes, between about 5 minutes to about 250 minutes, between about 5 minutes to about 200 minutes, between about 5 minutes to about 150 minutes, between about 5 minutes to about 100 minutes, between about 5 minutes to about 50 minutes, between about 5 minutes to about 30 minutes.

In some embodiments, the textiles or articles are contacted with the polypeptide or compositions comprising the polypeptide under conditions having a temperature that allows for biofilm prevention, reduction or removal from the textile or article. In some embodiments, the temperature in the methods disclosed herein include those between 10° to 60° C., between 10° to about 45° C., between 15° to about 55° C., between 15° to about 50° C., between 15° to about 45° C., between 20° to about 60° C., between 20° to about 50° C. and between 20° to about 45° C.

The polypeptides, compositions, and methods provided herein have utility in a wide array of applications in which preventing, reducing, or removing biofilms is desired, such as household cleaning, including in washing machines, dishwashers, and on household surfaces. The polypeptides, compositions, and methods also have applications in treating medical and dental biofilms, including but not limited to plaque on teeth, lung infections (e.g. Pulmozyme®), on catheters and implanted medical devices, on contact lenses, in medical instrument cleaning, and in wound healing. The polypeptides, compositions, and methods provided herein can also be used to treat biofouling in various industrial settings, including but not limited to in oil and gas recovery, water treatment facilities, in marine equipment, in animal care settings, and in food preservation.

Another embodiment is directed to a method of laundering a textile, where the method comprises contacting a textile with a polypeptide having thermolysin activity, or a composition comprising a polypeptide having thermolysin activity for an amount of time sufficient to prevent, reduce or remove a biofilm from the textile and optionally rinsing the textile.

Another embodiment is directed to a method for cleaning an article, where the method comprises contacting the article with a polypeptide having thermolysin activity or a composition having a polypeptide having thermolysin activity under conditions sufficient reduce or remove a biofilm from the article, and optionally rinsing the article.

### Compositions

In one embodiment, the disclosure provides compositions (e.g. detergent compositions) for use in the methods provided herein. The compositions generally comprise a polypeptide having thermolysin activity and one or more additional detergent components, such as a surfactant.

The compositions having a polypeptide having thermolysin activity, which find use in the methods provided herein, may comprise a polypeptide having thermolysin activity at a concentration of in use of 0.001 to 10,000 mg/L, or 0.001 to 2000 mg/L, or 0.01 to 5000 mg/L, or 0.01 to 2000 mg/L, or 0.01 to 1300 mg/L, or 0.1 to 5000 mg/L, or 0.1 to 2000 mg/L, or 0.1 to 1300 mg/L, or 1 to 5000 mg/L, or 1 to 1300 mg/L, or 1 to 500 mg/L, or 10 to 5000 mg/L, or 10 to 1300 mg/L, or 10 to 500 mg/L. In another embodiment, the composition may contain a polypeptide having thermolysin activity in an amount of 0.002 to 5000 mg of protein, such as 0.005 to 1300 mg of protein, or 0.01 to 5000 mg of protein, or 0.01 to 1300 mg of protein, or 0.1 to 5000 mg of protein, or 1 to 1300 mg of protein, preferably 0.1 to 1300 mg of protein, more preferably 1 to 1300 mg of protein, even more preferably 10 to 500 mg of protein, per liter of wash liquor, or in the amount of at least 0.002 ppm active thermolysin. In another embodiment, the detergent composition comprises a polypeptide having thermolysin activity in an amount to provide the thermolysin in a wash liquor in an amount of between 0.1 to 5000 ppm, between about 0.1 to 2500 ppm, between about 0,1 to 1500 ppm, between about 0.1 to 1300 ppm, between about 0.1 to 1000 ppm, between about 0.1 to 500 ppm, between 1 to 1300 ppm, between 10 to 1300 ppm, between about 10 and 500 PPM, between about 50 and 1300 ppm, between about 50 and 500 ppm in the wash liquor.

In one embodiment, the composition comprises a thermolysin and at least one additional detergent component, and optionally one or more additional enzymes.

The thermolysin polypeptide for use in the methods and compositions herein includes any thermolysin polypeptide. As used herein, the term “thermolysin” refers any member of the M4 protease family as described in MEROPS—The Peptidase Data base (See, Rawlings et al., MEROPS: the peptidase database, Nucl Acids Res, 34 Database issue, D270-272 [2006]), of which thermolysin (TLN; EC 3.4.24.27) is the prototype. The amino acid sequence of one embodiment of thermolysin is the neutral metallo endo-peptidase secreted from Bacillus thermoproteolyticus and the sequence set forth as UniProtKB/Swiss-Prot Accession No. P00800 (SEQ ID NO:1). Thermolysin polypeptide includes homologs, variants and active fragments of SEQ ID NO: 1. The terms “thermolysin,” “stearolysin”, “bacillolysin,” “proteinase-T”, “PrT”, “Thermolysin-like protease”, and “TLPs”, are used interchangeably herein to refer to the neutral metalloprotease enzyme having the amino acid sequence of SEQ ID NO: 1, or those having at least 60%, 65%, 70%, 75%, 80%, 85%, 90%, 95%, or greater sequence identity to SEQ ID NO: 1.

As used herein, “homologous genes” refers to a pair of genes from different, but usually related species, which correspond to each other and which are identical or very similar to each other. The term encompasses genes that are separated by speciation (i.e., the development of new species) (e.g., orthologous genes), as well as genes that have been separated by genetic duplication (e.g., paralogous genes).

As used herein, the term “variant polypeptide” refers to a polypeptide comprising an amino acid sequence that differs in at least one amino acid residue from the amino acid sequence of a parent or reference polypeptide (including but not limited to wild-type polypeptides).

As used herein, “the genus Bacillus” includes all species within the genus “Bacillus,” as known to those of skill in the art, including but not limited to B. subtilis, B. licheniformis, B. lentus, B. brevis, B. stearothermophilus, B. alkalophilus, B. amyloliquefaciens, B. clausii, B. halodurans, B. megaterium, B. coagulans, B. circulans, B. lautus, and B. thuringiensis. It is recognized that the genus Bacillus continues to undergo taxonomical reorganization. Thus, it is intended that the genus include species that have been reclassified, including but not limited to such organisms as B. stearothermophilus, which is now named “Geobacillus stearothermophilus.” The production of resistant endospores in the presence of oxygen is considered the defining feature of the genus Bacillus, although this characteristic also applies to the recently named Alicyclobacillus, Amphibacillus, Aneurinibacillus, Anoxybacillus, Brevibacillus, Filobacillus, Gracilibacillus, Halobacillus, Paenibacillus, Salibacillus, Thermobacillus, Ureibacillus, and Virgibacillus.

In some embodiments, the thermolysin for use in the compositions and methods provided herein includes a polypeptide having an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has thermolysin activity. In some embodiments, the thermolysin has an amino acid sequence having at least 50%, 55%, 60%, 65%, 70%, 75%, 80%, 85%, 90%, 91%, 92%, 93%, 94%, 95%, 96%, 97%, 98%, 99% or 100% sequence identity to SEQ ID NO: 1 and has the ability to prevent, reduce or remove a biofilm.

As used herein, “thermolysin activity” and “proteolytic activity” refers to a protein or polypeptide exhibiting the ability to hydrolyze peptides or substrates having peptide linkages. Methods for measuring proteolytic activity are known, and include comparative assays, which analyze the respective protease's ability to hydrolyze a commercial substrate. Other methods include those provided herein. Exemplary substrates useful in the analysis of protease or proteolytic activity, include, but are not limited to, di-methyl casein (Sigma C-9801), bovine collagen (Sigma C-9879), bovine elastin (Sigma E-1625), and bovine keratin (ICN Biomedical 902111). Colorimetric assays utilizing these substrates are well known in the art (See e.g., WO99/34011 and U.S. Pat. No. 6,376,450). The pNA peptidyl assay (See e.g., Del Mar et al., Anal Biochem, 99:316-320, 1979) also finds use in determining the active enzyme concentration. This assay measures the rate at which p-nitroaniline is released as the enzyme hydrolyzes a soluble synthetic substrate, such as succinyl-alanine-alanine-proline-phenylalanine-p-nitroanilide (suc-AAPF-pNA). The rate of production of yellow color from the hydrolysis reaction is measured at 405 or 410 nm on a spectrophotometer and is proportional to the active enzyme concentration. In addition, absorbance measurements at 280 nanometers (nm) can be used to determine the total protein concentration in a sample of purified protein. The activity on substrate/protein concentration gives the enzyme specific activity.

As used herein, “% identity or percent identity” refers to sequence similarity. Percent identity may be determined using standard techniques known in the art (See e.g., Smith and Waterman, Adv. Appl. Math. 2:482 [1981]; Needleman and Wunsch, J. Mol. Biol. 48:443 [1970]; Pearson and Lipman, Proc. Natl. Acad. Sci. USA 85:2444 [1988]; software programs such as GAP, BESTFIT, FASTA, and TFASTA in the Wisconsin Genetics Software Package (Genetics Computer Group, Madison, Wis.); and Devereux et al., Nucl. Acid Res. 12:387-395 [1984]). One example of a useful algorithm is PILEUP. PILEUP creates a multiple sequence alignment from a group of related sequences using progressive, pair-wise alignments. It can also plot a tree showing the clustering relationships used to create the alignment. PILEUP uses a simplification of the progressive alignment method of Feng and Doolittle (See, Feng and Doolittle, J. Mol. Evol. 35:351-360 [1987]). The method is similar to that described by Higgins and Sharp (See, Higgins and Sharp, CABIOS 5:151-153 [1989]). Useful PILEUP parameters include a default gap weight of 3.00, a default gap length weight of 0.10, and weighted end gaps. Other useful algorithm is the BLAST algorithms described by Altschul et al., (See, Altschul et al., J. Mol. Biol. 215:403-410 [1990]; and Karlin and Altschul, Proc. Natl. Acad. Sci. USA 90:5873-5787 [1993]). The BLAST program uses several search parameters, most of which are set to the default values.

As used herein, “homologous proteins” or “homologous proteases” refers to proteins that have distinct similarity in primary, secondary, and/or tertiary structure. Protein homology can refer to the similarity in linear amino acid sequence when proteins are aligned. Homology can be determined by amino acid sequence alignment, e.g., using a program such as BLAST, MUSCLE, or CLUSTAL. Homologous search of protein sequences can be done using BLASTP and PSI-BLAST from NCBI BLAST with threshold (E-value cut-off) at 0.001. (Altschul et al., “Gapped BLAST and PSI BLAST a new generation of protein database search programs”, Nucleic Acids Res, Set 1; 25(17):3389-402(1997)). The BLAST program uses several search parameters, most of which are set to the default values. The NCBI BLAST algorithm finds the most relevant sequences in terms of biological similarity but is not recommended for query sequences of less than 20 residues (Altschul et al., Nucleic Acids Res, 25:3389-3402, 1997 and Schaffer et al., Nucleic Acids Res, 29:2994-3005, 2001). Exemplary default BLAST parameters for a nucleic acid sequence searches include: Neighboring words threshold=11; E-value cutoff=10; Scoring Matrix=NUC.3.1 (match=1, mismatch=-3); Gap Opening=5; and Gap Extension=2. Exemplary default BLAST parameters for amino acid sequence searches include: Word size=3; E-value cutoff=10; Scoring Matrix=BLOSUM62; Gap Opening=11; and Gap extension=1. Using this information, protein sequences can be grouped and/or a phylogenetic tree built therefrom. Amino acid sequences can be entered in a program such as the Vector NTI Advance suite and a Guide Tree can be created using the Neighbor Joining (NJ) method (Saitou and Nei, Mol Biol Evol, 4:406-425, 1987). The tree construction can be calculated using Kimura's correction for sequence distance and ignoring positions with gaps. A program such as AlignX can display the calculated distance values in parentheses following the molecule name displayed on the phylogenetic tree.

A percent (%) amino acid sequence identity value is determined by the number of matching identical residues divided by the total number of residues of the “reference” sequence including any gaps created by the program for optimal/maximum alignment. If a sequence is 90% identical to SEQ ID NO: A, SEQ ID NO: A is the “reference” sequence. BLAST algorithms refer the “reference” sequence as “query” sequence.

The CLUSTAL W algorithm is another example of a sequence alignment algorithm (See, Thompson et al., Nucleic Acids Res, 22:4673-4680, 1994). Default parameters for the CLUSTAL W algorithm include: Gap opening penalty=10.0; Gap extension penalty=0.05; Protein weight matrix=BLOSUM series; DNA weight matrix=IUB; Delay divergent sequences %=40; Gap separation distance=8; DNA transitions weight=0.50; List hydrophilic residues=GPSNDQEKR; Use negative matrix=OFF; Toggle Residue specific penalties=ON; Toggle hydrophilic penalties=ON; and Toggle end gap separation penalty=OFF. In CLUSTAL algorithms, deletions occurring at either terminus are included. For example, a variant with a five amino acid deletion at either terminus (or within the polypeptide) of a polypeptide of 500 amino acids would have a percent sequence identity of 99% (495/500 identical residues×100) relative to the “reference” polypeptide. Such a variant would be encompassed by a variant having “at least 99% sequence identity” to the polypeptide.

In some embodiments, the thermolysin for use herein includes those thermolysin polypeptides described in WO2015/066669.

In some embodiments, the thermolysin polypeptide for use herein includes variants of thermolysin, including those disclosed in WO2014071410 and US20140099698, US201880073006, EP3260538, and US20180066244.

Also provided are detergent compositions for use in the methods provided herein. As used herein, the term “detergent composition” or “detergent formulation” is used in reference to a composition intended for use in a wash medium (e.g. a wash liquor) for the cleaning of soiled or dirty objects, including particular textile or non-textile objects or items. Such compositions of the present invention are not limited to any particular detergent composition or formulation. Indeed, in some embodiments, the detergents of the invention comprise at least one thermolysin polypeptide (e.g. Proteinase T) and, in addition, one or more surfactants, transferase(s), hydrolytic enzymes, oxido reductases, builders (e.g., a builder salt), bleaching agents, bleach activators, bluing agents, fluorescent dyes, caking inhibitors, masking agents, enzyme activators, antioxidants, and/or solubilizers. In some instances, a builder salt is a mixture of a silicate salt and a phosphate salt, preferably with more silicate (e.g., sodium metasilicate) than phosphate (e.g., sodium tripolyphosphate). Some compositions of the invention, such as, but not limited to, cleaning compositions or detergent compositions, do not contain any phosphate (e.g., phosphate salt or phosphate builder).

In some embodiments, the cleaning or detergent compositions of the present invention further comprise adjunct materials including, but not limited to, surfactants, builders, bleaches, bleach activators, bleach catalysts, other enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents (See e.g., U.S. Pat. Nos. 6,610,642, 6,605,458, 5,705,464, 5,710,115, 5,698,504, 5,695,679, 5,686,014 and 5,646,101, all of which are incorporated herein by reference).

The detergent or cleaning compositions of the present invention are advantageously employed for example, in laundry applications, hard surface cleaning, dishwashing applications, as well as cosmetic applications such as dentures, teeth, hair and skin. In addition, due to the unique advantages of increased effectiveness in lower temperature solutions, the enzymes of the present invention are ideally suited for laundry applications. Furthermore, the enzymes of the present invention find use in granular and liquid compositions.

Enzyme component weights are based on total active protein. All percentages and ratios are calculated by weight unless otherwise indicated. All percentages and ratios are calculated based on the total composition unless otherwise indicated. In laundry detergent compositions, the enzyme levels are expressed in ppm, which equals mg active protein/kg detergent composition.

In some embodiments, the laundry detergent compositions described herein further comprise a surfactant. In some embodiments, the surfactant is selected from a non-ionic, ampholytic, semi-polar, anionic, cationic, zwitterionic, and combinations and mixtures thereof. In yet a further embodiment, the surfactant is selected from an anionic surfactant, a cationic surfactant, a zwitterionic surfactant, and combinations thereof. In some embodiments, the laundry detergent compositions described herein comprise from about 0.1% to about 60%, about 1% to about 50%, or about 5% to about 40% surfactant by weight of the composition.

Exemplary surfactants include, but are not limited to sodium dodecylbenzene sulfonate, C12-14 pareth-7, C12-15 pareth-7, sodium C12-15 pareth sulfate, C14-15 pareth-4, sodium laureth sulfate (e.g., Steol CS-370), sodium hydrogenated cocoate, C12 ethoxylates (Alfonic 1012-6, Hetoxol LA7, Hetoxol LA4), sodium alkyl benzene sulfonates (e.g., Nacconol 90G), and combinations and mixtures thereof. Anionic surfactants include but are not limited to linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap. Nonionic surfactants include but are not limited to alcohol ethoxylate (AEO or AE), carboxylated alcohol ethoxylates, nonylphenol ethoxylate, alkylpolyglycoside, alkyldimethylamine oxide, ethoxylated fatty acid monoetha.nolamide, fatty acid monoethanolamide, polyhydroxy alkyl fatty acid amide (e.g., as described in WO92/06154), polyoxyethylene esters of fatty acids, polyoxyethylene sorbitan esters (e.g., TWEENs), polyoxyethylene alcohols, polyoxyethylene isoalcohois, polyoxyethylene ethers (e.g., TRITONs and BRIJ), polyoxyethylene esters, polyoxyethylene-p-tert-octylphenols or octylphenyl-ethylene oxide condensates (e.g., NONIDET P40), ethylene oxide condensates with fatty alcohols (e.g., LUBROL), polyoxyethylene nonylphenols, polyalkylene glycols (SYNPERONIC F108), sugar-based surfactants (e.g., glycopyranosides, thioglycopyranosides), and combinations and mixtures thereof.

In a further embodiment, the laundry detergent compositions described herein further comprise a surfactant mixture that includes, but is not limited to 5-15% anionic surfactants, <5% nonionic surfactants, cationic surfactants, phosphonates, soap, enzymes, perfume, butylphenyl methylpropionate, geraniol, zeolite, polycarboxylates, hexyl cinnamal, limonene, cationic surfactants, citronellol, and benzisothiazolinone.

The laundry detergent compositions described herein may additionally include one or more detergent builders or builder systems, a complexing agent, a polymer, a bleaching system, a stabilizer, a foam booster, a suds suppressor, an anti-corrosion agent, a soil-suspending agent, an anti-soil redeposition agent, a dye, a bactericide, a hydrotope, an optical brightener, a fabric conditioner, and a perfume. The laundry detergent compositions described herein may also include additional enzymes selected from proteases, amylases, cellulases, lipases, mannanases, nucleases, pectinases, xyloglucanases, or perhydrolases, as provided in more detail herein.

In some embodiments, the laundry detergent compositions described herein further comprises from about 1%, from about 3% to about 60% or even from about 5% to about 40% builder by weight of the cleaning composition. Builders may include, but are not limited to, the alkali metals, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metals, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

In some embodiments, the builders form water-soluble hardness ion complexes (e.g., sequestering builders), such as citrates and polyphosphates (e.g., sodium tripolyphosphate and sodium tripolyphospate hexahydrate, potassium tripolyphosphate, and mixed sodium and potassium tripolyphosphate, etc.). Any suitable builder can find use in the compositions described herein, including those known in the art.

In some embodiments, the laundry detergent compositions described herein further comprise an adjunct ingredient including, but not limited to surfactants, builders, bleaches, bleach activators, bleach catalysts, additional enzymes, an enzyme stabilizer (including, for example, an enzyme stabilizing system), chelants, optical brighteners, soil release polymers, dye transfer agents, dye transfer inhibiting agents, catalytic materials, hydrogen peroxide, sources of hydrogen peroxide, preformed peracids, polymeric dispersing agents, clay soil removal agents, structure elasticizing agents, dispersants, suds suppressors, dyes, perfumes, colorants, filler salts, hydrotropes, photoactivators, fluorescers, fabric conditioners, hydrolyzable surfactants, solvents, preservatives, anti-oxidants, anti-shrinkage agents, anti-wrinkle agents, germicides, fungicides, color speckles, anti-corrosion agents, alkalinity sources, solubilizing agents, carriers, processing aids, pigments, pH control agents, and combinations thereof. (See, e.g., U.S. Pat. Nos. 6,610,642, 6,605,458, 5,705,464, 5,710,115, 5,698,504, 5,695,679, 5,686,014, and 5,646,101). In some embodiments, one or more adjunct is incorporated for example, to assist or enhance cleaning performance, for treatment of the substrate to be cleaned, or to modify the aesthetics of the cleaning composition as is the case with perfumes, colorants, dyes or the like. Any such adjunct ingredient is in addition to the low temperature mannanase, low temperature amylase, and/or low temperature protease described herein. In some embodiments, the adjunct ingredient is selected from surfactants, enzyme stabilizers, builder compounds, polymeric compounds, bleaching agents, additional enzymes, suds suppressors, dispersants, lime-soap dispersants, soil suspension agents, softening agents, anti-redeposition agents, corrosion inhibitors, and combinations thereof.

In some further embodiments, the laundry detergent compositions described herein comprise one or more enzyme stabilizer. In some embodiments, the enzyme stabilizer is a water-soluble source of calcium and/or magnesium ions. In some embodiments, the enzyme stabilizers include oligosaccharides, polysaccharides, and inorganic divalent metal salts, including alkaline earth metals, such as calcium salts. In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), tin (II), cobalt (II), copper (II), nickel (II), and oxovanadium (IV)). Chlorides and sulfates also find use in some embodiments. Exemplary oligosaccharides and polysaccharides (e.g., dextrins) are described, for example, in WO07145964. In some embodiments, the laundry detergent compositions described herein contain reversible protease inhibitors selected from a boron-containing compound (e.g., borate, 4-formyl phenyl boronic acid, and phenyl-boronic acid derivatives, such as, e.g., are described in WO9641859); a peptide aldehyde (such as, e.g., is described in WO2009118375 and WO2013004636), and combinations thereof.

The cleaning compositions herein are typically formulated such that, during use in aqueous cleaning operations, the wash water will have a pH of from about 3.0 to about 11. Liquid product formulations are typically formulated to have a neat pH from about 5.0 to about 9.0, more preferably from about 7.5 to about 9. Granular laundry products are typically formulated to have a pH from about 8.0 to about 11.0. Techniques for controlling pH at recommended usage levels include the use of buffers, alkalis, acids, etc., and are well known to those skilled in the art.

Suitable high pH cleaning compositions typically have a neat pH of from about 9.0 to about 11.0, or even a neat pH of from 9.5 to 10.5. Such cleaning compositions typically comprise a sufficient amount of a pH modifier, such as sodium hydroxide, monoethanolamine, or hydrochloric acid, to provide such cleaning composition with a neat pH of from about 9.0 to about 11.0. Such compositions typically comprise at least one base-stable enzyme. In some embodiments, the compositions are liquids, while in other embodiments, they are solids.

In one embodiment, the cleaning compositions include those having a pH of from 7.4 to pH 11.5, or pH 7.4 to pH 11.0, or pH 7.5 to pH 11.5, or pH 7.5 to pH 11.0, or pH 7.5 to pH 10.5, or pH 7.5 to pH 10.0, or pH 7.5 to pH 9.5, or pH 7.5 to pH 9.0, or pH 7.5 to pH 8.5, or pH 7.5 to pH 8.0, or pH 7.6 to pH 11.5, or pH 7.6 to pH 11.0, or pH 7.6 to pH 10.5, or pH 8.7 to pH 10.0, or pH 8.0 to pH 11.5, or pH 8.0 to pH 11.0, or pH 8.0 to pH 10.5, or pH 8.0 to pH 10.0.

Concentrations of detergent compositions in typical wash solutions throughout the world vary from less than about 800 ppm of detergent composition (“low detergent concentration geographies”), for example about 667 ppm in Japan, to between about 800 ppm to about 2000 ppm (“medium detergent concentration geographies”), for example about 975 ppm in U.S. and about 1500 ppm in Brazil, to greater than about 2000 ppm (“high detergent concentration geographies”), for example about 4500 ppm to about 5000 ppm in Europe and about 6000 ppm in high suds phosphate builder geographies.

In some embodiments, the detergent compositions described herein may be utilized at a temperature of from about 10° C. to about 60° C., or from about 20° C. to about 60° C., or from about 30° C. to about 60° C., from about 40° C. to about 60° C., from about 40° C. to about 55° C., or all ranges within 10° C. to 60° C. In some embodiments, the detergent compositions described herein are used in “cold water washing” at temperatures of from about 10° C. to about 40° C., or from about 20° C. to about 30° C., from about 15° C. to about 25° C., from about 15° C. to about 35° C., or all ranges within 10° C. to 40° C.

As a further example, different geographies typically have different water hardness. Water hardness is usually described in terms of the grains per gallon mixed Ca²⁺/Mg²⁺. Hardness is a measure of the amount of calcium (Ca²⁺) and magnesium (Mg²⁺) in the water. Most water in the United States is hard, but the degree of hardness varies. Moderately hard (60-120 ppm) to hard (121-181 ppm) water has 60 to 181 parts per million (parts per million converted to grains per U.S. gallon is ppm # divided by 17.1 equals grains per gallon) of hardness minerals.

TABLE I
Water Hardness Levels

| Water | Grains per gallon | Parts per million |
|---|---|---|
| Soft | less than 1.0 | less than 17 |
| Slightly hard | 1.0 to 3.5 | 17 to 60 |
| Moderately hard | 3.5 to 7.0 | 60 to 120 |
| Hard | 7.0 to 10.5 | 120 to 180 |
| Very hard | greater than 10.5 | greater than 180 |

European water hardness is typically greater than about 10.5 (for example about 10.5 to about 20.0) grains per gallon mixed Ca²⁺/Mg²⁺ (e.g., about 15 grains per gallon mixed Ca²⁺/Mg²⁺). North American water hardness is typically greater than Japanese water hardness, but less than European water hardness. For example, North American water hardness can be between about 3 to about 10 grains, about 3 to about 8 grains or about 6 grains. Japanese water hardness is typically lower than North American water hardness, usually less than about 4, for example about 3 grains per gallon mixed Ca²⁺/Mg²⁺.

In other embodiments, the composition described herein comprises one or more additional enzyme. The one or more additional enzyme is selected from acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, DNases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof. Some embodiments are directed to a combination of enzymes (i.e., a “cocktail”) comprising enzymes like amylase, protease, lipase, mannanase, and/or nuclease in conjunction with one or more thermolysin polypeptides in the compositions provided herein.

In some embodiments, the compositions provided herein comprise a polypeptide having thermolysin activity in combination with a protease. The protease for use in combination with the thermolysin in the compositions of the instant disclosure include any polypeptide having protease activity. In one embodiment, the additional protease is a serine protease. In another embodiment, the additional protease is an additional metalloprotease, a fungal subtilisin, or an alkaline microbial protease or a trypsin-like protease. Suitable additional proteases include those of animal, vegetable or microbial origin. In some embodiments, the protease is a microbial protease. In other embodiments, the protease is a chemically or genetically modified mutant. In another embodiment, the protease is subtilisin like protease or a trypsin-like protease. In other embodiments, the additional protease does not contain cross-reactive epitopes with the variant as measured by antibody binding or other assays available in the art. Exemplary subtilisin proteases include those derived from for example, Bacillus (e.g., e.g., BPN', Carlsberg, subtilisin 309, subtilisin 147, and subtilisin 168), or fungal origin, such as, for example, those described in U.S. Pat. No. 8,362,222. Exemplary additional proteases include but are not limited to those described in WO92/21760, WO95/23221, WO2008/010925, WO09/149200, WO09/149144, WO09/149145, WO 10/056640, WO10/056653, WO2010/0566356, WO11/072099, WO2011/13022, WO11/140364, WO 12/151534, WO2015/038792, WO2015/089447, WO2015/089441, WO 2017/215925, US Publ. No. 2008/0090747, U.S. Pat. Nos. 5,801,039, 5,340,735, 5,500,364, 5,855,625, RE 34,606, U.S. Pat. Nos. 5,955,340, 5,700,676 6,312,936, 6,482,628, 8,530,219, US Provisional Appl Nos. 62/180673 and 62/161077, and PCT Appl Nos. PCT/U52015/021813, PCT/U52015/055900, PCT/U52015/057497, PCT/U52015/057492, PCT/U52015/057512, PCT/U52015/057526, PCT/U52015/057520, PCT/U52015/057502, PCT/US2016/022282, and PCT/US16/32514, International publications WO2016001449, WO2016087617, WO2016096714, WO2016203064, WO2017089093, and WO2019180111, as well as metalloproteases described in WO1999014341, WO1999033960, WO1999014342, WO1999034003, WO2007044993, WO2009058303, WO 2009058661, WO2014071410, WO2014194032, WO2014194034, WO 2014194054, and WO 2014/194117. Exemplary additional proteases include, but are not limited to trypsin (e.g., of porcine or bovine origin) and the Fusarium protease described in WO89/06270. Exemplary commercial proteases include, but are not limited to MAXATASE®MAXACAL™MAXAPEM™OPTICLEAN®, OPTIMASE®PROPERASE®PURAFECT®, PURAFECT® OXP, PURAMAX™EXCELLASE™ PREFERENZ™ proteases (e.g. P100, P110, P280), EFFECTENZ™ proteases (e.g. P1000, P1050, P2000), EXCELLENZ™ proteases (e.g. P1000), ULTIMASE®and PURAFAST™ (DuPont); ALCALASE®BLAZE®, BLAZE® variants, BLAZE® EVITY®, BLAZE® EVITY® 16L, CORONASE®, SAVINASE®, SAVINASE® ULTRA, SAVINASE® EVITY®, SAVINASE® EVERTS®, PRIMASE®, DURAZYM™POLARZYME®OVOZYME®, KANNASE®LIQUANASE®, LIQUANASE EVERTS®, NEUTRASE®, PROGRESS UNO®, RELASE , and ESPERASE® (Novozymes); BLAP™ and BLAP™ variants (Henkel); LAVERGY™ PRO 104 L (BASF), KAP (B. alkalophilus subtilisin (Kao)) and BIOTOUCH® (AB Enzymes).

In some embodiments, the compositions provided herein comprise a polypeptide having thermolysin activity in combination with one or more amylases. In one embodiment, the composition comprises from about 0.00001% to about 10%, about 0.0001% to about 10%, about 0.001% to about 5%, about 0.001% to about 2%, or about 0.005% to about 0.5% amylase by weight composition. Any amylase (e.g., alpha and/or beta) suitable for use in alkaline solutions may be useful to include in such composition. An exemplary amylase can be a chemically or genetically modified mutant. Exemplary amylases include, but are not limited to those of bacterial or fungal origin, such as, for example, amylases described in GB 1,296,839, WO9100353, WO9402597, WO94183314, WO9510603, WO9526397, WO9535382, WO9605295, WO9623873, WO9623874, WO 9630481, WO9710342, WO9741213, WO9743424, WO9813481, WO 9826078, WO9902702, WO 9909183, WO9919467, WO9923211, WO9929876, WO9942567, WO 9943793, WO9943794, WO 9946399, WO0029560, WO0060058, WO0060059, WO0060060, WO 0114532, WO0134784, WO 0164852, WO0166712, WO0188107, WO0196537, WO02092797, WO 0210355, WO0231124, WO 2004055178, WO2004113551, WO2005001064, WO2005003311, WO 2005018336, WO2005019443, WO2005066338, WO2006002643, WO2006012899, WO2006012902, WO2006031554, WO 2006063594, WO2006066594, WO2006066596, WO2006136161, WO 2008000825, WO2008088493, WO2008092919, WO2008101894, WO2008/112459, WO2009061380, WO2009061381, WO 2009100102, WO2009140504, WO2009149419, WO 2010/059413, WO 2010088447, WO2010091221, WO2010104675, WO2010115021, WO10115028, WO2010117511, WO 2011076123, WO2011076897, WO2011080352, WO2011080353, WO 2011080354, WO2011082425, WO2011082429, WO 2011087836, WO2011098531, WO2013063460, WO2013184577, WO 2014099523, WO2014164777, and WO2015077126. Exemplary commercial amylases include, but are not limited to AMPLIFY®, DURAMYL®, TERMAMYL®, FUNGAMYL®, STAINZYME®, STAINZYME PLUS®, STAINZYME PLUS®, STAINZYME ULTRA®EVITY®, and BAN™ (Novozymes); EFFECTENZ™ S 1000, POWERASE™PREFERENZ™ S 100, PREFERENZ™ S 110, EXCELLENZ™ S 2000, RAPIDASE® and MAXAMYL® P (DuPont).

In some embodiments, the compositions provided herein comprise a polypeptide having thermolysin activity in combination with one or more lipases. In some embodiments, the composition comprises from about 0.00001% to about 10%, about 0.0001% to about 10%, about 0.001% to about 5%, about 0.001% to about 2%, or about 0.005% to about 0.5% lipase by weight composition. An exemplary lipase can be a chemically or genetically modified mutant. Exemplary lipases include, but are not limited to, e.g., those of bacterial or fungal origin, such as, e.g., H. lanuginosa lipase (see, e.g., EP 258068 and EP 305216), T. lanuginosa lipase (see, e.g., WO 2014/059360 and WO2015/010009), Rhizomucor miehei lipase (see, e.g., EP 238023), Candida lipase, such as C. antarctica lipase (e.g., C. antarctica lipase A or B) (see, e.g., EP 214761), Pseudomonas lipases such as P. alcaligenes and P. pseudoalcaligenes lipase (see, e.g., EP 218272), P. cepacia lipase (see, e.g., EP 331376), P. stutzeri lipase (see, e.g., GB 1,372,034), P. fluorescens lipase, Bacillus lipase (e.g., B. subtilis lipase (Dartois et al., Biochem. Biophys. Acta 1131:253-260 (1993)), B. stearothermophilus lipase (see, e.g., JP 64/744992), and B. pumilus lipase (see, e.g., WO 91/16422)). Exemplary cloned lipases include, but are not limited to Penicillium camembertii lipase (See, Yamaguchi et al., Gene 103:61-67 (1991)), Geotrichum candidum lipase (See, Schimada et al., J. Biochem., 106:383-388 (1989)), and various Rhizopus lipases, such as, R. delemar lipase (See, Hass et al., Gene 109:117-113 (1991)), R. niveus lipase (Kugimiya et al., Biosci. Biotech. Biochem. 56:716-719 (1992)) and R. oryzae lipase. Other lipolytic enzymes, such as cutinases, may also find use in one or more composition described herein, including, but not limited to, e.g., cutinase derived from Pseudomonas mendocina (see, WO 88/09367) and/or Fusarium solani pisi (see, WO90/09446). Exemplary commercial lipases include, but are not limited to M1 LIPASE™LUMA FAST™and LIPOMAX™ (DuPont); LIPEX®, LIPOCLEAN®, LIPOLASE® and LIPOLASE® ULTRA (Novozymes); and LIPASE P™ (Amano Pharmaceutical Co. Ltd).

In some embodiments, the compositions provided herein comprise a polypeptide having thermolysin activity in combination with one or more mannanases. In one embodiment, the composition comprises from about 0.00001% to about 10%, about 0.0001% to about 10%, about 0.001% to about 5%, about 0.001% to about 2%, or about 0.005% to about 0.5% mannanase by weight composition. An exemplary mannanase can be a chemically or genetically modified mutant. Exemplary mannanases include, but are not limited to, those of bacterial or fungal origin, such as, for example, those described in WO 2016/007929; U.S. Pat. Nos. 6,566,114; 6,602,842; and 6,440,991: and US Provisional Appl. Nos. 62/251516, 62/278383, and 62/278387. Exemplary commercial mannanases include, but are not limited to MANNAWAY® (Novozymes) and EFFECTENZ™ M 1000, EFFECTENZ™ M 2000, PREFERENZ® M 100, MANNASTAR®, and PURABRITE™ (DuPont).

In some embodiments, the compositions and methods provided herein comprise a polypeptide having thermolysin activity in combination with a nuclease, such as a DNase or RNase. Exemplary nucleases include, but are not limited to, those described in WO2015181287, WO2015155350, WO2016162556, WO2017162836, WO2017060475 (e.g. SEQ ID NO: 21), WO2018184816, WO2018177936, WO2018177938, WO2018/185269, WO2018185285, WO2018177203, WO2018184817, WO2019084349, WO2019084350, WO2019081721, WO2018076800, WO2018185267, WO2018185280, and WO2018206553. Other nucleases which can be used in combination with the polypeptides having thermolysin activity in the compositions and methods provided herein include those described in Nijland R, Hall M J, Burgess J G (2010) Dispersal of Biofilms by Secreted, Matrix Degrading, Bacterial DNase. PLoS ONE 5(12) and Whitchurch, C. B., Tolker-Nielsen, T., Ragas, P. C., Mattick, J. S. (2002) Extracellular DNA required for bacterial biofilm formation. Science 295: 1487.

Yet a still further embodiment is directed to a composition comprising one or more thermolysins described herein and one or more cellulase. In one embodiment, the composition comprises from about 0.00001% to about 10%, 0.0001% to about 10%, about 0.001% to about 5%, about 0.001% to about 2%, or about 0.005% to about 0.5% cellulase by weight of composition. Any suitable cellulase may find use in a composition described herein. An exemplary cellulase can be a chemically or genetically modified mutant. Exemplary cellulases include but are not limited, to those of bacterial or fungal origin, such as, for example, those described in WO2005054475, WO2005056787, U.S. Pat. Nos. 7,449,318, 7,833,773, 4,435,307; EP 0495257; and US Provisional Appl. No. 62/296,678. Exemplary commercial cellulases include, but are not limited to, CELLUCLEAN®, CELLUZYME®, CAREZYME®, ENDOLASE®, RENOZYME®, and CAREZYME® PREMIUM (Novozymes); REVITALENZ™ 100, REVITALENZ™ 200/220, and REVITALENZ® 2000 (DuPont); and KAC-500(B)™ (Kao Corporation). In some embodiments, cellulases are incorporated as portions or fragments of mature wild-type or variant cellulases, wherein a portion of the N-terminus is deleted (see, e.g., U.S. Pat. No. 5,874,276).

In other embodiments, the composition described herein comprises one or more additional biofilm controlling agents, such as alginate oligomers and probiotics. Alginate oligomers for use in such compositions include those, for example, in U.S. Pat. No. 10,624,920. Probiotics for use in the compositions include those disclosed, for example, in WO2020008053, WO2018060475, WO2017157774, and WO2017142743.

In some embodiments, the laundry detergent compositions described herein comprise at least one chelating agent. Suitable chelating agents may include, but are not limited to copper, iron, and/or manganese chelating agents, and mixtures thereof. In some embodiments, the laundry detergent compositions described herein comprises from about 0.1% to about 15% or even from about 3.0% to about 10% chelating agent by weight of composition.

In some still further embodiments, the laundry detergent compositions described herein comprise at least one deposition aid. Suitable deposition aids include, but are not limited to, polyethylene glycol, polypropylene glycol, polycarboxylate, soil release polymers such as polyterephthalic acid, clays such as kaolinite, montmorillonite, attapulgite, illite, bentonite, halloysite, and mixtures thereof.

In some embodiments, the laundry detergent compositions described herein comprise at least one anti-redeposition agent.

In some embodiments, the laundry detergent compositions described herein comprise one or more dye transfer inhibiting agent. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones, and polyvinylimidazoles, or mixtures thereof. In some embodiments, the laundry detergent compositions described herein comprise from about 0.0001% to about 10%, from about 0.01% to about 5%, or even from about 0.1% to about 3% dye transfer inhibiting agent by weight of composition.

In some embodiments, the laundry detergent compositions described herein comprise one or more silicates. In some such embodiments, sodium silicates (e.g., sodium disilicate, sodium metasilicate, and crystalline phyllosilicates) find use. In some embodiments, the laundry detergent compositions described herein comprise from about 1% to about 20% or from about 5% to about 15% silicate by weight of the composition.

In yet further embodiments, the laundry detergent compositions described herein comprise one or more dispersant. Suitable water-soluble organic materials include, but are not limited to the homo- or co-polymeric acids or their salts, in which the polycarboxylic acid comprises at least two carboxyl radicals separated from each other by not more than two carbon atoms.

In some embodiments, the laundry detergent compositions described herein comprise one or more bleach, bleach activator, and/or bleach catalyst. In some embodiments, the laundry detergent compositions described herein comprise inorganic and/or organic bleaching compound(s). Inorganic bleaches may include, but are not limited to perhydrate salts (e.g., perborate, percarbonate, perphosphate, persulfate, and persilicate salts). In some embodiments, inorganic perhydrate salts are alkali metal salts. In some embodiments, inorganic perhydrate salts are included as the crystalline solid, without additional protection, although in some other embodiments, the salt is coated. Suitable salts include, for example, those described in EP2100949. Bleach activators are typically organic peracid precursors that enhance the bleaching action in the course of cleaning at temperatures of 60° C. and below. Bleach activators suitable for use herein include compounds which, under perhydrolysis conditions, give aliphatic peroxycarboxylic acids having preferably from about 1 to about 10 carbon atoms, in particular from about 2 to about 4 carbon atoms, and/or optionally substituted perbenzoic acid. Bleach catalysts typically include, for example, manganese triazacyclononane and related complexes, and cobalt, copper, manganese, and iron complexes, as well as those described in U.S. Pat. Nos. 4,246,612, 5,227,084, 4,810,410, WO9906521, and EP2100949.

In some embodiments, the laundry detergent compositions described herein comprise one or more catalytic metal complex. In some embodiments, a metal-containing bleach catalyst finds use. In other embodiments, the metal bleach catalyst comprises a catalyst system comprising a transition metal cation of defined bleach catalytic activity (e.g., copper, iron, titanium, ruthenium, tungsten, molybdenum, or manganese cations), an auxiliary metal cation having little or no bleach catalytic activity (e.g., zinc or aluminum cations), and a sequestrate having defined stability constants for the catalytic and auxiliary metal cations, particularly ethylenediaminetetraacetic acid, ethylenediaminetetra (methylenephosphonic acid) and water-soluble salts thereof are used (See, e.g., U.S. Pat. No. 4,430,243). In some embodiments, the laundry detergent compositions described herein are catalyzed by means of a manganese compound. Such compounds and levels of use are well known in the art (See, e.g., U.S. Pat. No. 5,576,282). In additional embodiments, cobalt bleach catalysts find use in the laundry detergent compositions described herein. Various cobalt bleach catalysts are known in the art (See, e.g., U.S. Pat. Nos. 5,597,936 and 5,595,967) and are readily prepared by known procedures.

Some embodiments are directed to a method of cleaning comprising contacting an effective amount of a cleaning composition described herein with an item or surface comprising a soil, stain or biofilm to hydrolyze the soil, stain or biofilm.

Other aspects and embodiments of the present compositions and methods will be apparent from the foregoing description and following examples. Various alternative embodiments beyond those described herein can be employed in practicing the invention without departing from the spirit and scope of the invention. Accordingly, the claims, and not the specific embodiments described herein, define the scope of the invention and as such methods and structures within the scope of the claims and their equivalents are covered thereby.

### Embodiments

Embodiment 1. A method for preventing, reducing or removing a biofilm comprising contacting the biofilm with a polypeptide having thermolysin activity or a composition comprising a polypeptide having thermolysin activity.

Embodiment 2. The method of Embodiment 1, where the biofilm is on a textile or hard surface.

Embodiment 3. The method of Embodiment 2, where the hard surface is selected from the group consisting of a laundry machine surface, a dish surface, or a dishwasher surface.

Embodiment 4. The method of Embodiment 1, where the composition is a cleaning composition.

Embodiment 5. The method of Embodiments 1-4, where the cleaning composition is a laundry composition.

Embodiment 6. A method for preventing, reducing or removing a biofilm from a textile or hard surface comprising: (i) contacting a textile or surface with a polypeptide having thermolysin activity or a composition comprising a polypeptide having thermolysin activity; and (ii) optionally, rinsing the textile or surface.

Embodiment 7. The method of Embodiment 6, where the textile comprises a biofilm on a surface of the textile.

Embodiment 8. The method of Embodiment 7, where the biofilm is reduced or removed from the textile.

Embodiment 9. The method of any of the preceding Embodiments, where the biofilm is reduced or removed from the article in an amount selected from the groups consisting of at least 5%, 10%, 15%, 20%, 25%, 30%, 35%, 40%, 45%, 50%, 55%, 60%, 65%, 70%, 75%, 80%, 85%, 90%, 95% or greater compared to the amount of the biofilm present on the textile prior to contacting the textile with the polypeptide having thermolysin activity or a composition comprising a polypeptide having thermolysin activity.

Embodiment 10. The method of any of the preceding Embodiments, where the biofilm is measured using the method of Example 1.

Embodiment 11. The method of any of the preceding Embodiments, where the contacting step comprises the use a polypeptide having thermolysin activity in an amount selected from the group consisting of 0.002 to 10,000 mg of protein, 0.005 to 5000 mg of protein, 0.01 to 5000 mg of protein, 0.05 to 5000 mg of protein, 0.05 to 1300 mg of protein, 0.1 to 1300 mg of protein, 0.1 to 500 mg of protein, 0.1 to 100 mg of protein, per liter of wash liquor, or in the amount of at least 0.002 ppm active thermolysin.

Embodiment 12. The method of any of the preceding Embodiments, where the polypeptide having thermolysin activity is Proteinase T.

Embodiment 13. The method of any of the preceding Embodiments, where the contacting step occurs in a wash liquor.

Embodiment 14. The method of any of the preceding Embodiments, where the contacting step takes place for an amount of time selected from the group consisting of about 5 minutes to about 10 days, about 5 minutes to about 400 minutes, between about 5 minutes to about 300 minutes, between about 5 minutes to about 250 minutes, between about 5 minutes to about 200 minutes, between about 5 minutes to about 150 minutes, between about 5 minutes to about 100 minutes, between about 5 minutes to about 50 minutes, between about 5 minutes to about 30 minutes.

Embodiment 15. The method of any of the preceding Embodiments, where the contacting step takes place at a temperature selected from the group consisting of about 10° to 60° C., between 15° to about 55° C., between 20° to about 50° C. and between 20° to about 45° C.

Embodiment 16. The method of any of the preceding Embodiments, where the composition comprising a polypeptide having thermolysin activity further comprises a surfactant.

Embodiment 17. The method of Embodiment 16, where the surfactant is selected from the group consisting of a non-ionic, ampholytic, semi-polar, anionic, cationic, zwitterionic, and combinations and mixtures thereof.

Embodiment 18. The method of any of the preceding Embodiments, where the composition is a detergent composition.

Embodiment 19. The method of any of the preceding Embodiments, where the contacting step further includes contacting the textile with one or more additional enzymes selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof.

Embodiment 20. The method of any of the preceding Embodiments, where the contacting step takes place in a washing machine or a dishwasher.

Embodiment 21. A detergent composition comprising: (i) a polypeptide having thermolysin activity; (ii) a polypeptide having protease activity; (iii) at least one additional polypeptide, where the at least one additional polypeptide is an enzyme selected from: DNaseacyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases, oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof; and (iv) a surfactant.

Embodiment 22. The composition of Embodiment 21, where the surfactant is selected from the group consisting of a non-ionic, ampholytic, semi-polar, anionic, cationic, zwitterionic, and combinations and mixtures thereof.

Embodiment 23. The composition of Embodiment 21, where the composition comprises between about 0.1% to about 60%, about 1% to about 50%, or about 5% to about 40% surfactant by weight of the composition.

Embodiment 24. The composition of Embodiment 21, where the composition further comprises one or more adjunct materials selected from the group consisting of builders, bleaches, bleach activators, bleach catalysts, other enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents.

Embodiment 25. The composition of Embodiment 21, where the nuclease is a DNase.

### EXAMPLES

### Example 1. Dispersal of Pseudomonas fluorescens Biofilm

The commercial product, Proteinase T (DuPont), was further purified with a desalting column.

A biofilm dispersal assay was adapted from the procedure described by Pitts et al (Pitts, B., Hamilton, M. A., Zelver, N., Stewart, P. S. (2003) A microtiter-plate screening method for biofilm disinfection and removal. Journal of Microbiological Methods 54: 269-276), briefly as follows. Pseudomonas fluorescens (ATCC strain 700830) biofilm was formed on 96-well round bottom plate (Corning 2797). Briefly, seed cultures from an LB growth plate were inoculated in fresh TSB media followed by OD600 adjustment to 0.1-0.2. Then cell suspension was transferred to a microtiter plate and the plate was incubated in oxygen chamber statically for 48 h at 28 degrees C. After washing 5 times with 1X PBS and air-drying, the biofilm buildup in plates was treated with enzyme solution at the concentrations indicated, prepared in 50mM HEPES buffer pH 8.0 (buffer alone used as negative control). For each sample, eight replicates were performed. Plates were incubated in an iEMS incubator at 26 degrees C. with shaking at 400 rpm for 2 hours. Then treatment solutions were decanted, and the plate was washed 5 times with Milli-Q water and air dried. After treatment, biofilm was stained by crystal violet solution (0.1%). After 5 min, the excess crystal violet was removed and the plate was washed 5 times and air dried. Finally, the biofilm bound crystal violet was dissolved in 30% acetic acid solution. Biofilm was monitored in terms of OD590 nm using a spectrophotometer.

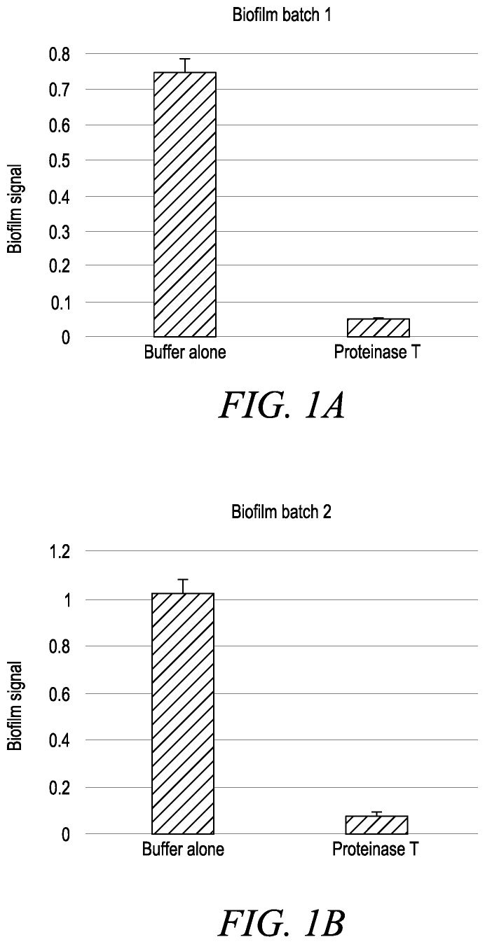

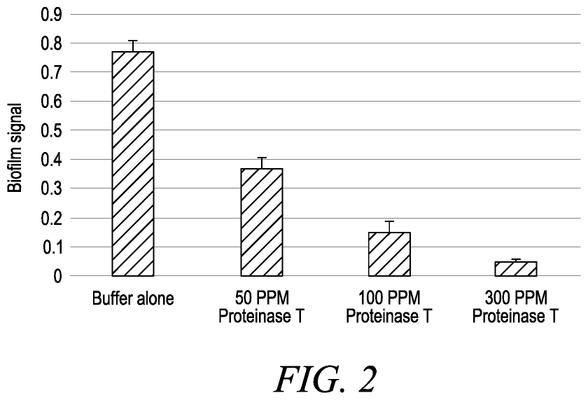

Results are shown in FIG. 1 for two independently grown batches of biofilm treated with 270 PPM Proteinase T or buffer alone. Proteinase T showed a 93.3% and 92.7% reduction in biofilm signal relative to the no-enzyme control for batch 1 and batch 2, respectively. The biofilm signal in the presence of 270 PPM Proteinase T was 6.7% of the no-enzyme control in (A) and 7.3% of the no-enzyme control in (B). Results are shown in FIG. 2 for three different concentrations of Proteinase T (50 PPM, 100 PPM, and 300 PPM).

### Example 2. Dispersal of Pseudomonas fluorescens Biofilm in a Simulated Laundry Wash

A biofilm dispersal assay was adapted from the procedure described by Pitts et al (Pitts, B., Hamilton, M. A., Zelver, N., Stewart, P. S. (2003) A microtiter-plate screening method for biofilm disinfection and removal. Journal of Microbiological Methods 54: 269-276.). To produce biofilms in 96-well plates, Pseudomonas fluorescens (ATCC 700830) was grown overnight (18-24 hours) at 28C, 200-220 rpm with Tryptic Soy Broth (TSB, Teknova T11550). Cultures were diluted to ˜0.1 OD600 units. These dilutions were used to seed microtiter plates (PVC U bottom 96 well plates, Corning 2797) with 100 μL per well×96 wells. The plates were sealed with breathable film or foil. The seeded microtiter plates were incubated for about 48 hours at 26° C. without agitation. The liquid was decanted and the plates were washed 3-5 times with phosphate buffered saline, then allowed to dry.

Proteinase T (DuPont), a commercial enzyme product, was used as supplied. The concentrations given are the quantitated enzyme concentrations. To simulate the wash treatment, approximately 150 μL of simulated wash solution was added to each well either with or without proteinase T added. The concentrations of Proteinase T used were 1300, 327, 82, 20, 5, 1.3, 0.32, 0.08, 0.02, and 0.005 PPM. The simulated wash solution consisted of Tide Original liquid laundry detergent at the approximate recommended laundry dosage (1:1200 dilution in water). The plates were sealed with foil and mixed briefly in a shaker (˜300 rpm), then incubated at 26° C. for 35-45 minutes with intermittent shaking to simulate a laundry wash cycle. The simulated wash solutions were decanted and the plates were washed 4-7 times with water. The plates were allowed to dry.

Biofilms were detected with crystal violet as follows. A 0.1% solution of crystal violet was dispensed into each well, 150 μL per well. The plates were incubated at room temperature for 10 minutes. The crystal violet solution was decanted and the plates were rinsed 3-5 times with water to remove unbound crystal violet. The plates were allowed to dry. Stain bound to biofilm was solubilized with a solution of 30% acetic acid, 150 μL per well. The absorbance at 590 nm was read on a spectrophotometer.

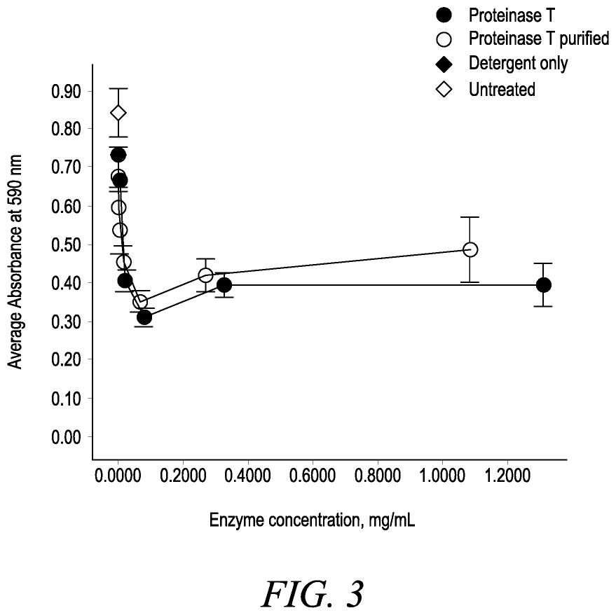

A substantial reduction of the Pseudomonas fluorescens biofilm was seen with Proteinase T concentrations of 1300 PPM, 327 PPM, 82 PPM, and 20 PPM (FIG. 3) FIG. 3 shows P. fluorescens biofilm treated with varied concentrations of Proteinase T. Error bars in FIG. 3 indicate standard deviation of 4 trials. White circles in FIG. 3 represent untreated controls. Light gray circles represent laundry simulation wash alone with no enzyme. Dark Gray circles in FIG. 3 represent varied doses of Proteinase T, as indicated. Black circles indicate results for a sample of Proteinase T subjected to additional purification.

### Example 3. Dispersal of Staphylococcus epidermidis biofilm in a simulated laundry wash

A biofilm dispersal assay was adapted from the procedure described by Pitts et al (Pitts, B., Hamilton, M. A., Zelver, N., Stewart, P. S. (2003) A microtiter-plate screening method for biofilm disinfection and removal. Journal of Microbiological Methods 54: 269-276.). To produce biofilms in 96-well plates Staphylococcus epidermidis (ATCC 35984) was grown overnight (18-24 hours) at 28C, 200-220 rpm with Tryptic Soy Broth (TSB, Teknova T11550). Cultures were diluted to —0.1 OD600 units. These dilutions were used to seed microtiter plates (non-tissue culture polystyrene U bottom 96 well plates, Corning 877254) with 100 μL per well×96 wells. The plates were sealed with breathable film or foil. The seeded microtiter plates were incubated for about 48 hours at 26° C. without agitation. The liquid was decanted and the plates were washed 3-5 times with phosphate buffered saline, then allowed to dry.

Proteinase T (DuPont), a commercial enzyme product, was used as supplied. The concentrations given are the quantitated enzyme concentrations.

To simulate the wash treatment, approximately 150 μL of simulated wash solution was added to each well either with or without proteinase T added. Proteinase T concentrations in the simulated washes were 10 PPM, 52 PPM, 260 PPM, or 1300 PPM. The simulated wash solution consisted of Tide Original liquid laundry detergent at the approximate recommended laundry dosage (1:1200 dilution in water). The plates were sealed with foil and mixed briefly in a shaker (˜300 rpm), then incubated at 26° C. for 35-45 minutes with intermittent shaking to simulate a laundry wash cycle. The simulated wash solutions were decanted and the plates were washed 4-7 times with water. The plates were allowed to dry.

Biofilms were detected with crystal violet as follows. A 0.1% solution of Crystal violet was dispensed into each well, 150 μL per well. The plates were incubated at room temperature for 10 minutes. The crystal violet solution was decanted and the plates were rinsed 3-5 times with water to remove unbound crystal violet. The plates were allowed to dry. Crystal violet stain bound to biofilm was solubilized with a solution of 30% acetic acid, 150 μL per well. The absorbance at 590 nm was read on a spectrophotometer.

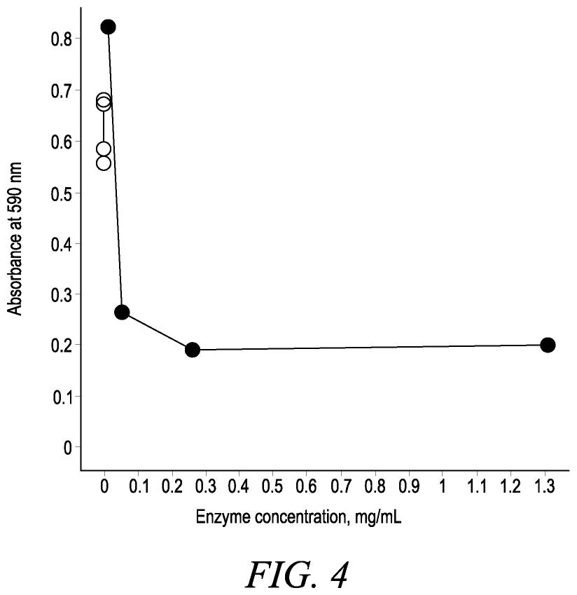

A substantial reduction of the Staphylococcus epidermidis biofilm was seen with Proteinase T concentrations of 52 PPM, 260 PPM, and 1300 PPM as shown in FIG. 4 S. epidermidis biofilm treated with varied concentrations of Proteinase T. (Light gray circles represent untreated controls. Dark gray circles represent laundry wash with the given concentration of Proteinase T (10 PPM, 52 PPM, 260 PPM, or 1300 PPM)).

### Example 4. Inhibition of Formation of Staphylococcus epidermidis Biofilm

Staphylococcus epidermidis (ATCC 35984) was grown overnight in a flask with brain heart infusion (BHI) broth at 30 degrees C. and agitation at 250 RPM. The OD600 of the overnight culture was measured and the culture was used to inoculate several petri dishes (VWR Cat. #25384-302) with 25 mL of fresh tryptic soy broth (TSB) media with cells at 0.1 OD600/mL. Proteinase T was included at 0, 10, 20, 40, or 80 PPM. The petri dishes were incubated for 48 hours at 30 degrees Celsius with ambient humidity and no agitation. Then the liquid culture was discarded and biofilm formation on the plate was assessed with crystal violet staining as follows.

Biofilms were rinsed with PBS three times each and allowed to dry at room temperature. Crystal violet solution (20 mL of 0.1% w/v crystal violet in water) was added to each petri dish. The solution was allowed to permeate the biofilms without agitation for 1 hour. The excess crystal violet solution was poured off and the plates were rinsed three times each with water. The stained biofilms were dried at room temperature and photographed. Next, 20 mL of a destaining solution (30% v/v glacial acetic acid in water) was applied to each petri dish and rocked gently to mix. The absorbance at 590 nm of this destain solution was measured with a spectrophotometer by dilution until the OD590 was between 0.1 and 1.0 and then calculation of the OD590 of the undiluted solution by accounting for the dilution factor.

Biofilm formation, as measured by crystal violet staining, was substantially reduced by treatment with Proteinase T. Table 1 gives OD590 values. At 10 PPM thermolysin, the biofilm formation with Staphylococcus epidermidis under these conditions was reduced by 42%. With 40 PPM thermolysin, the biofilm formation was reduced by 76%.

TABLE 1
OD590 values from crystal violet staining
for the undiluted destain solution.

| PPM thermolysin | OD590 |
|---|---|
| 0 | 44.9 |
| 10 | 25.9 |
| 20 | 22.6 |
| 40 | 11 |
| 80 | 3.03 |

### Example 5. Staphylococcus epidermidis Biofilm Formation is Inhibited Without Reduction of Planktonic Cells

Staphylococcus epidermidis (ATCC 35984) was grown overnight in a flask with tryptic soy broth (TSB) media at 31 degrees C. and agitation at 200 RPM. The OD600 of the overnight culture was measured and the culture was used to inoculate several petri dishes (VWR Cat. #25384-302) with 25 mL of fresh tryptic soy broth (TSB) media with cells at 0.1 OD600/mL. Proteinase T was included at 0, 1, 2, 5, 10, 15, 20, or 80 PPM. The petri dishes were incubated for 54 hours at 30 degrees Celsius with ambient humidity and no agitation. A 2-mL sample of each liquid culture was drawn off for determination of planktonic cell density using a spectrophotometer, measuring OD600. Then the remainder of the liquid culture was discarded and biofilm formation on the plate was assessed with crystal violet staining as follows.

Biofilms were rinsed with PBS three times each and allowed to dry at room temperature. Crystal violet solution (20 mL of 0.1% w/v crystal violet in water) was added to each petri dish. The solution was allowed to permeate the biofilms without agitation for 1 hour. The excess crystal violet solution was poured off and the plates were rinsed three times each with water. The stained biofilms were dried at room temperature and photographed. Next, 20 mL of a destaining solution (30% v/v glacial acetic acid in water) was applied to each petri dish and rocked gently to mix. The absorbance at 590 nm of this detstain solution was measured with a spectrophotometer by dilution until the OD590 was between 0.1 and 1.0 and then calculation of the OD590 of the undiluted solution by accounting for the dilution factor.

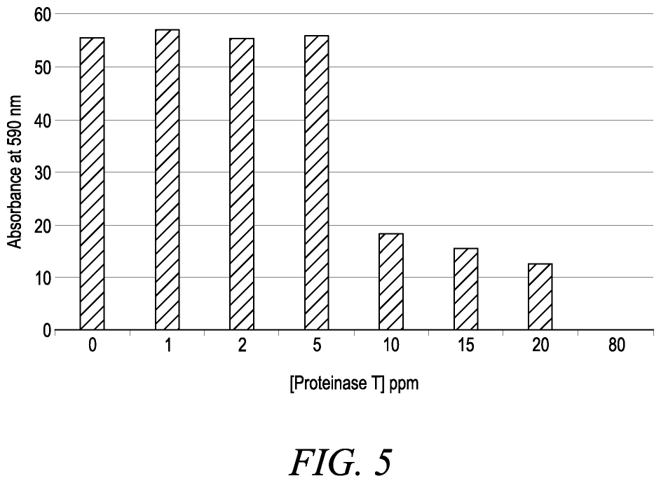

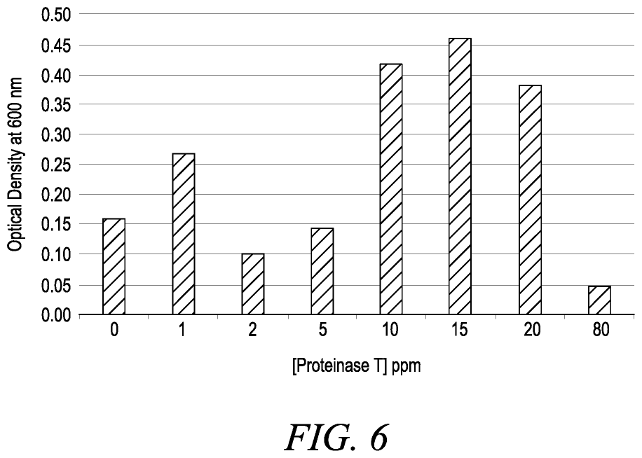

As in Example 4, above, biofilm formation was reduced in the presence of Proteinase T (Table 2 and FIG. 5). In this experiment, the density of the cell culture was also measured, as shown in Table 2 and FIG. 6. The density of the culture (0D600) did not decrease with increasing Proteinase T, indicating that the Proteinase T was not killing or lysing the cells. In contrast, the cell density increased with increasing dose of Proteinase T, possibly because the cells remained in solution rather than forming biofilm on the plate surface.

TABLE 2

| | OD590 | OD600 |
|---|---|---|
| PPM thermolysin | (Biofilm) | (Planktonic Cells) |
| 0 | 55.5 | 0.158 |
| 1 | 57.1 | 0.267 |
| 2 | 55.4 | 0.1 |
| 5 | 55.9 | 0.143 |
| 10 | 18.4 | 0.418 |
| 15 | 15.6 | 0.459 |
| 20 | 12.7 | 0.383 |
| 80 | 0.128 | 0.047 |

### Example 6. Cleaning of Biofilms in Midscale Launder-Ometer Wash

A midscale model of laundry washing machine biofilms was prepared using the Launder-Ometer (SDL Atlas) as follows. Three stainless steel plates were prepared such that they formed an equilateral triangle inside the Launder-Ometer pod. The plates were autoclaved. In each Launder-Ometer pod, two plates were left sterile and the third was treated as follows to generate a biofilm on one surface.

Brain heart infusion (BHI) broth was inoculated with Staphylococcus epidermidis (ATCC 35984) and the culture was grown overnight at 37° C. and 250 RPM overnight in a shaker. The OD600 of the overnight culture was determined. With the resulting value, a solution of tryptic soy broth (TSB) and overnight culture was made such that the resulting OD600 of the final cell suspension was between 0.1 and 0.2. For each Launder-Ometer pod used, 100 mL of this cell suspension was added to a large, sterile petri dish containing one autoclaved stainless steel plate. The gap between petri dish and lid was completely sealed with an adhesive seal. The petri dishes were placed in a 25° C. incubator with approximately 70% humidity and incubated without agitation for 48 hours. After incubation, the liquid cell culture was discarded and the stainless steel plates were washed with sterile PBS buffer. The biofilms were allowed to dry at room temperature.

The biofilm-coated stainless steel plates were placed into the Launder-Ometer pods such that each pod contained one biofilm-coated plate and two sterile plates. The biofilm faced outward, away from the central chamber formed by the triangle of three plates, thus mimicking washing machine biofilms formed on interior surfaces of washing machines, such as the outside of the washer drum. The laundrometer pots, O-rings, and spacers used to hold the steel plates in place were sterilized by autoclaving or by exposure to sterilizing UV light for 45 minutes. Eight sterile polyester fabric swatches (texturized polyester interlock knit fabric, Testfabrics #1410003) were placed in the central chamber formed by the triangle of steel plates inside the pods. Wash test solutions (200 mL each) were added to each pot and the Launder-Ometer was run for 30 minutes at 25 degrees Celsius. The wash test solutions were filter sterilized and contained Liquid Tide Original laundry detergent at a dose of 0.78 g/L in deionized water. Thermolysin (Proteinase T, DuPont) was added at 40 PPM or 80 PPM to some pots as indicated. After the wash, the wash solution was removed and the pot and its contents were rinsed with sterile deionized water. After each wash, two fabric swatches were removed for analysis and the remaining fabric swatches as well as the washed, rinsed biofilm plate were placed into a new, clean Launder-Ometer pod. Three washes were performed in total.

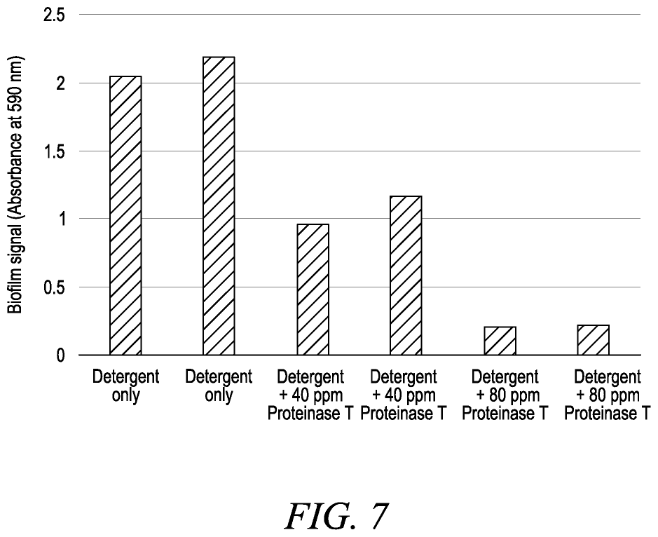

After the three washes and rinses, the biofilm plates were stained with a 0.1% solution of crystal violet in water for 10 minutes at room temperature. The plates were rinsed twice in water for 10 minutes with gentle mixing. The plates were then destained with 30% acetic acid (100 mL per pot). The absorbance at 590 nm of the destain solution was measured, diluting and calculating for the dilution factor if needed. FIG. 7 shows the absorbance at 590 nm, a measure of the amount of biofilm remaining, for tests performed in duplicate.

### Example 7. Prevention of the Transfer of Bacteria to Fabric in Midscale Launder-Ometer Wash Laundry Wash

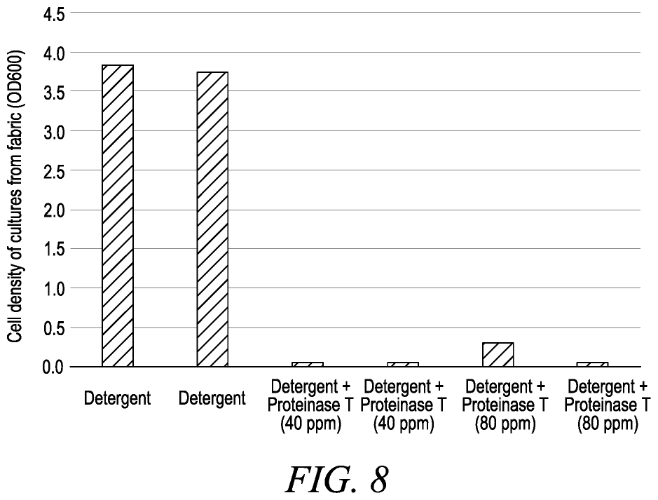

As described in Example 6, biofilms were generated and washed with sterile fabrics in a midscale model of washing machine biofilms. After three washes as described in Example 6, one washed polyester fabric swatch from each Launder-Ometer pot was placed in a sterile 250 mL baffled shake flask with 100 mL TSB. The culture was grown for 16 hours at 37 degrees Celsius, 85% humidity, and shaking at 150 rpm. The absorbance at 600 nm was measured to determine the cell density in the cultures (FIG. 8). Samples treated with Proteinase T showed reduced cell density, whereas samples treated with detergent alone showed significant cell density.

### Example 8. Reduction in Malodor by Simulated Laundry Wash with Thermolysin Treatment

Brain heart infusion (BHI) broth was inoculated with Staphylococcus epidermidis (ATCC 35984) and the culture was grown at 30 degrees Celsius and 250 RPM overnight in a shaker. The OD600 of the overnight culture was determined. With the resulting OD600 value, a solution of tryptic soy broth (TSB) and overnight culture was made such that the final cell suspension was approximately 0.1 OD600/mL. The cell suspension (25 mL) was added to polystyrene petri dishes (VWR 25384-088) and the dishes were incubated at 30 degrees Celsius without agitation for 52 hours. After incubation, the liquid cell culture was discarded and the dishes were washed with sterile PBS buffer. The biofilms were allowed to dry at room temperature.

The biofilms were subjected to a simulated laundry wash at 25 degrees Celsius on a shaker set to 50 rpm for 30 minutes. The wash solutions consisted of the following treatments: Tide Free and Gentle liquid laundry detergent at wash concentration (1200-fold dilution in water) both with and without 80 PPM Proteinase T and also Tide Original liquid laundry detergent at wash concentration (1200-fold dilution in water) both with and without 80 PPM Proteinase T. After the simulated wash, the biofilms were rinsed with water for 8 minutes at 25 degrees Celsius on a shaker set to 50 rpm. After rinsing, the biofilms were allowed to dry at room temperature.

A synthetic sweat solution was added to each biofilm-containing petri dish. The synthetic sweat solution contained the following components.

| Component | Weight % |
|---|---|
| Glucose | 1% |
| Sodium Chloride | 0.5% |
| Disodium hydrogen orthophosphate dodecahydrate | 0.5% |
| Leucine | 0.1% |
| Casamino acids | 0.1% |
| L-Histidine | 0.05% |
| Potassium phosphate dibasic | 2.52 × 10⁻⁴% |
| Ammonium nitrate | 3.6 × 10⁻⁴% |
| Ferrous sulfate | 7.2 × 10⁻⁷% |
| Magnesium sulfate | 2.52 × 10⁻⁴% |
| Potassium phosphate monobasic | 2.52 × 10⁻⁴% |
| Zinc sulfate | 7.2 × 10⁻⁷% |

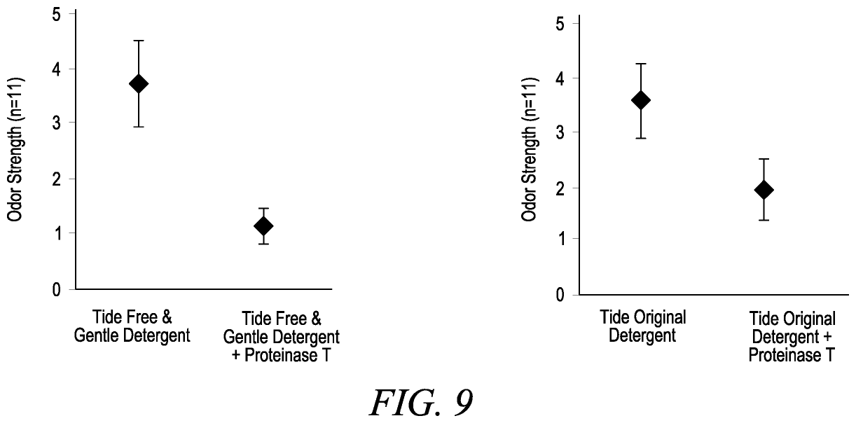

The biofilms were incubated with the synthetic sweat solution at 30 degrees Celsius for 4 days with no agitation. The synthetic sweat solution was then removed from the petri dishes and evaluated by an odor sensory panel of 11 participants. The odor panel was asked to evaluate the odor strength on a scale from 1 (little or no odor) to 5 (very strong odor). The results are plotted in FIG. 9.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A method for preventing, reducing or removing a biofilm comprising contacting the biofilm with a cleaning composition comprising a polypeptide having thermolysin activity.

2. The method of claim 1, wherein the biofilm is on a textile or hard surface.

3. The method of claim 2, wherein the hard surface is selected from the group consisting of a laundry machine surface, a dish surface, or a dishwasher surface.

4. The method of any of the preceding claims, wherein the cleaning composition comprises a polypeptide having thermolysin activity in an amount selected from 0.001 to 10,000 mg/L, or 0,001 to 2000 mg/L, or 0.01 to 5000 mg/L, or 0.01 to 2000 mg/L, or 0.01 to 1300 mg/L, or 0.1 to 5000 mg/L, or 0.1 to 2000 mg/L, or 0.1 to 1300 mg/L, or 1 to 5000 mg/L, or 1 to 1300 mg/L, or 1 to 500 mg/L, or 10 to 5000 or 10 to 1300 mg/L, or 10 to 500 mg/L.

5. The method of any of the preceding claims, wherein the cleaning composition is a laundry composition.

6. A method for preventing, reducing or removing a biofilm from a textile or hard surface comprising: (i) contacting a textile or surface with a polypeptide having thermolysin activity or a composition comprising a polypeptide having thermolysin activity; and (ii) optionally, rinsing the textile or surface.

7. The method of claim 6, wherein the textile comprises a biofilm on a surface of the textile.

8. The method of claim 7, wherein the biofilm is reduced or removed from the textile.

9. The method of any of the preceding claims, wherein the biofilm is reduced or removed from the article in an amount selected from the groups consisting of at least 5%, 10%, 15%, 20%, 25%, 30%, 35%, 40%, 45%, 50%, 55%, 60%, 65%, 70%, 75%, 80%, 85%, 90%, 95% or greater compared to the amount of the biofilm present on the textile prior to contacting the textile with the polypeptide having thermolysin activity or a composition comprising a polypeptide having thermolysin activity.

10. The method of any of the preceding claims, wherein the biofilm is measured using the method of Example 1.

11. The method of any of the preceding claims, wherein the contacting step comprises the use a polypeptide having thermolysin activity in an amount selected from the group consisting 0.002 to 10,000 mg of protein, 0.0055 to 5000 mg of protein, 0.01 to 5000 mg of protein, 0.05 to 5000 mg of protein, 0.05 to 1300 mg of protein, 0.1 to 1300 mg of protein, 0.1 to 500 mg of protein, 0.1 to 100 mg of protein, per liter of wash liquor, or in the amount of at least 0.002 ppm active thermolysin.

12. The method of any of the preceding claims, wherein the cleaning composition has a pH of from 7.4 to pH 11.5, or pH 7.4 to pH 11.0, or pH 7.5 to pH 11.5.

13. The method of any of the preceding claims, wherein the polypeptide having thermolysin activity is a polypeptide having at least 80%, 85%, 90%, 95%, 98%, 99%, or 100% sequence identity to SEQ ID NO: 1.

14. The method of any of the preceding claims, wherein the contacting step occurs in a wash liquor.

15. The method of any of the preceding claims, wherein the contacting step takes place for an amount of time selected from the group consisting of about 5 minutes to about 10 days, about 5 minutes to about 400 minutes, between about 5 minutes to about 300 minutes, between about 5 minutes to about 250 minutes, between about 5 minutes to about 200 minutes, between about 5 minutes to about 150 minutes, between about 5 minutes to about 100 minutes, between about 5 minutes to about 50 minutes, between about 5 minutes to about 30 minutes.

16. The method of any of the preceding claims, wherein the contacting step takes place at a temperature selected from the group consisting of about 10° to 60° C., between 15° to about 55° C., between 20° to about 50° C. and between 20° to about 45° C.

17. The method of any of the preceding claims, wherein the composition comprising a polypeptide having thermolysin activity further comprises a surfactant.

18. The method of claim 17, wherein the surfactant is selected from the group consisting of a non-ionic, ampholytic, semi-polar, anionic, cationic, zwitterionic, and combinations and mixtures thereof.

19. The method of any of the preceding claims, wherein the composition is a detergent composition.

20. The method of any of the preceding claims, wherein the contacting step further includes contacting the textile with one or more additional enzymes selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof.

21. The method of any of the preceding claims, wherein the contacting step takes place in a washing machine or a dishwasher.

22. A detergent composition comprising: (i) a polypeptide having thermolysin activity; (ii) a polypeptide having protease activity; (iii) at least one additional polypeptide, wherein the at least one additional polypeptide is an enzyme selected from: DNaseacyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases, oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof; and (iv) a surfactant.

23. The composition of claim 22, wherein the surfactant is selected from the group consisting of a non-ionic, ampholytic, semi-polar, anionic, cationic, zwitterionic, and combinations and mixtures thereof.

24. The composition of claim 22, wherein the composition comprises between about 0.1% to about 60%, about 1% to about 50%, or about 5% to about 40% surfactant by weight of the composition.

25. The composition of claim 22, wherein the composition further comprises one or more adjunct materials selected from the group consisting of builders, bleaches, bleach activators, bleach catalysts, other enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents.

26. The composition of claim 22, wherein the nuclease is a DNase.

27. A method for reducing malodor associated with a textile or hard surface comprising:
(i) contacting a textile or hard surface with a polypeptide having thermolysin activity or a composition comprising a polypeptide having thermolysin activity; and (ii) optionally, rinsing the textile or surface.

28. The method of claim 27, wherein the textile comprises a biofilm on a surface of the textile or hard surface.

29. The method of claim 28, wherein the biofilm is reduced or removed from the textile.

30. The method of any of claims 27 to 28, wherein the malodor is reduced at least 5%, 10%, 15%, 20%, 25%, 30%, 35%, 40%, 45%, 50%, 55%, 60%, 65%, 70%, 75%, 80%, 85%, 90%, 95% or greater compared to the amount of the malodor present prior to contacting the textile or hard surface with the polypeptide having thermolysin activity or a composition comprising a polypeptide having thermolysin activity.

31. The method of any of claims 27 to 30, wherein the contacting step comprises the use a polypeptide having thermolysin activity in an amount selected from the group consisting of 0.002 to 10,000 mg of protein, 0.005 to 5000 mg of protein, 0.01 to 5000 mg of protein, 0.05 to 5000 mg of protein, 0.05 to 1300 mg of protein, 0.1 to 1300 mg of protein. 0.1 to 500 mg of protein, 0.1 to 100 mg of protein, per liter of wash liquor, or in the amount of at least 0.002 ppm active thermolysin.

32. The method of any of claims 27-31, wherein the polypeptide having thermolysin activity is a polypeptide having at least 80%, 85%, 90%, 95%, 96%, 97%, 98%, 99%, or 100% sequence identity to SEQ ID NO: 1.

33. The method of any of claims 27-32, wherein the polypeptide having thermolysin activity is Proteinase T.

34. The method of any of claims 27-33, wherein the contacting step occurs in a wash liquor.

35. The method of any of claims 27-34, wherein the contacting step takes place at a temperature selected from the group consisting of about 10° to 60° C., between 15° to about 55° C., between 20° to about 50° C. and between 20° to about 45° C.

36. The method of any of claims 27-35, wherein the composition comprising a polypeptide having thermolysin activity further comprises a surfactant.

37. The method of claim 36, wherein the surfactant is selected from the group consisting of a non-ionic, ampholytic, semi-polar, anionic, cationic, zwitterionic, and combinations and mixtures thereof.

38. The method of any of claims 27-37, wherein the composition is a detergent composition.

39. The method of any of claims 27-38, wherein the contacting step further includes contacting the textile with one or more additional enzymes selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof.

40. The method of any of claims 27-39, wherein the contacting step takes place in a washing machine or a dishwasher.


SEQUENCE LISTING (1 sequence)

SEQ ID NO: 1 - protein, 316 aa, Bacillus thermoproteolyticus
ITGTSTVGVGRGVLGDQKNINTTYSTYYYLQDNTRGNGIFTYDAKYRTTLPGSLWADADNQFFASYDAPAVDAHYYAGVTYDYYKNVHNRLSYDGNNAAIRSSVHYSQGYNNAFWNGSQMVYGDGDGQTFIPLSGGIDVVAHELTHAVTDYTAGLIYQNESGAINEAISDIFGTLVEFYANKNPDWEIGEDVYTPGISGDSLRSMSDPAKYGDPDHYSKRYTGTQDNGGVHINSGIINKAAYLISQGGTHYGVSVVGIGRDKLGKIFYRALTQYLTPTSNFSQLRAAAVQSATDLYGSTSQEVASVKQAFDAVGVK